(19) United States
(12) Patent Application Publication
(10) Pub. No.: US 2002/0083035 A1
(43) Pub. Date: Jun. 27, 2002

(54) System and method for wireless delivery of text data

(76) Inventors: Ronald G. Pearl, Roswell, GA (US); Sun Yaojun, Marietta, GA (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 09/847,647

(22) Filed: May 2, 2001

Related U.S. Application Data
(60) Provisional application No. 60/201,983, filed on May 3, 2000.
(60) Provisional application No. 60/206,606, filed on May 23, 2000.
(60) Provisional application No. 60/277,843, filed on Mar. 22, 2001.

(51) Int. Cl. G06F 7/00

(52) U.S. Cl. 707/1

(57) ABSTRACT

The present invention discloses a system and method for the wireless delivery of text data from a file associated with a Uniform Resource Locator on a computer network.

### CROSS-REFERENCE TO RELATED APPLICATIONS

This application claims priority to provisional patent applications No. 60/201,983, filed May 3, 2000, Ser. No. 60/206,606, filed May 23, 2000, and Ser. No. 60/277,843, filed Mar. 22, 2001, which are relied on and incorporated herein by reference.

### BACKGROUND

The rapid increase in the use of wireless devices has been accompanied by a rapid increase in functionality of such devices. One-way wireless message receipt initially gave rise to two-way wireless messaging, such as short messaging systems (SMS). More recently, WAP-enabled and “pocket” Internet browser-enabled devices now allow wireless Internet access, and direct retrieval of wireless markup language (WML) and hypertext markup language (HTML) web pages, respectively. However, Internet-enabled device costs and associated service fees have limited the number of Internet-enabled wireless devices in the market. Further, many users owning “legacy” wireless devices, such as traditional one-way and two-way messaging capable devices, are simply not interested in the purchase of a replacement device.

A need therefore exists for enabling users of two-way messaging capable wireless devices to access the wealth of data available from Internet web pages through widespread and less costly messaging systems already in place. In particular, the ability to strip text content from web pages and provide the text data to these legacy devices is needed.

Accordingly, the present invention answers this need by providing a system and method for providing text data from Internet files with an associated Uniform Resource Locator (URL), including navigation and user interaction capability, to a wireless device.

### SUMMARY OF THE INVENTION

The present invention provides a system and method for wireless delivery of text content from a file associated with a Uniform Resource Locator (URL) on a computer network to a wireless device.

In an embodiment of the present invention, a user requests text content to be extracted from an Internet web page for delivery to a wireless device capable of one-way or two-way messaging, but unable to retrieve content associated with markup language web pages, such as HTML, WML, XML, SMIL, SGML, SHTML, CHTML, and the like. A wireless platform retrieves the requested page from its URL and translates the content to a text format compatible for display on the wireless device. Based on a destination address associated with the wireless device, the platform sends the text content from the web page in an e-mail message to the device. The user can view the text data on the wireless device from the delivered e-mail message.

It is an object of the present invention to provide, in addition to web page text content delivery, the ability to bookmark a URL-identified file from a wireless device. Preferably, a user bookmarks a file by sending a message with a bookmark-indicating command code, the URL to be bookmarked, and the short code/bookmark for abbreviating the URL to the wireless platform. The platform receives the message, and, recognizing the bookmark command code, assigns the short code to the URL for future requests for the file from the wireless device address.

It is a further object of the present invention to provide for the request and navigation of web pages via two-way messaging from a wireless device. Preferably, to request a web page, a user sends an e-mail request to the wireless platform including a request command code designating that the message is a request for the web page indicated in the message. The request command code may include a URL or a short code designating the URL. Upon receiving the message, the platform recognizes the command code and retrieves the web page for translation to text data and return e-mail delivery to the address associated with the wireless device. For navigation, the platform preferably extracts hyperlinks from a requested web page and assigns a requesting identifier, such as a number to each hyperlink. When the web page content is translated to text for e-mail delivery to the device, each hyperlink, where appearing in the text message, includes the corresponding number. After receiving the delivered message with text content, a user can reply to the platform with a command code indicating a navigation request from the previous message for a hyperlinked page and the number of the requested hyperlink. The platform receives the reply message and retrieves the requested hyperlink for text translation and delivery in a new e-mail message to the wireless device.

It is a further object of the present invention to provide for data entry of a URL-identified file from a wireless device. Preferably, as in the embodiment of the invention for enabling navigation, data entry fields are designated with a number or symbol in the text content delivery of a requested web page from the platform. A user replies to the message containing the data entry indicators with a command code for data entry, the corresponding data entry field, and the data to be entered. The platform receives the message, enters the data in the corresponding web page, and retrieves, translates, and forwards the text data for the web page resulting after data entry to the wireless device.

In another embodiment of the present invention, a user can schedule text content from one or more web pages to be sent to the wireless device at a scheduled time. Preferably, a user visits a scheduling web page via a traditional Internet connection and enters the URL(s) for desired web page content along with a scheduled time, such as date and hour, for delivery to the wireless device. Based on the user-defined scheduled, the platform retrieves the requested web page at the requested time, translates the web page content to text data, and delivers the text content in an e-mail message to the address associated with the user's wireless device.

### BRIEF DESCRIPTION OF THE DRAWINGS

FIG. 1 is a relational schematic diagram illustrating platform architecture in an embodiment of the present invention.

FIG. 2 is a relational block diagram illustrating event process flow and module framework in an embodiment of the present invention.

### DETAILED DESCRIPTION OF THE INVENTION

The present invention provides a system and method for the delivery of text data associated with files identified by a Uniform Resource Locator (URL), such as web pages, to wireless devices, including mobile phones, personal digital assistants (PDAs), pagers, wireless computers, and the like.

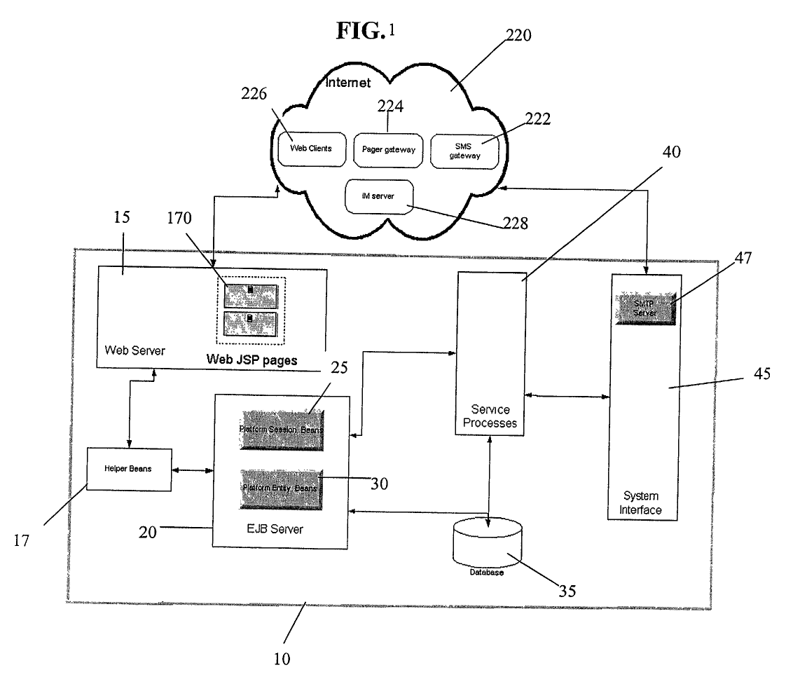

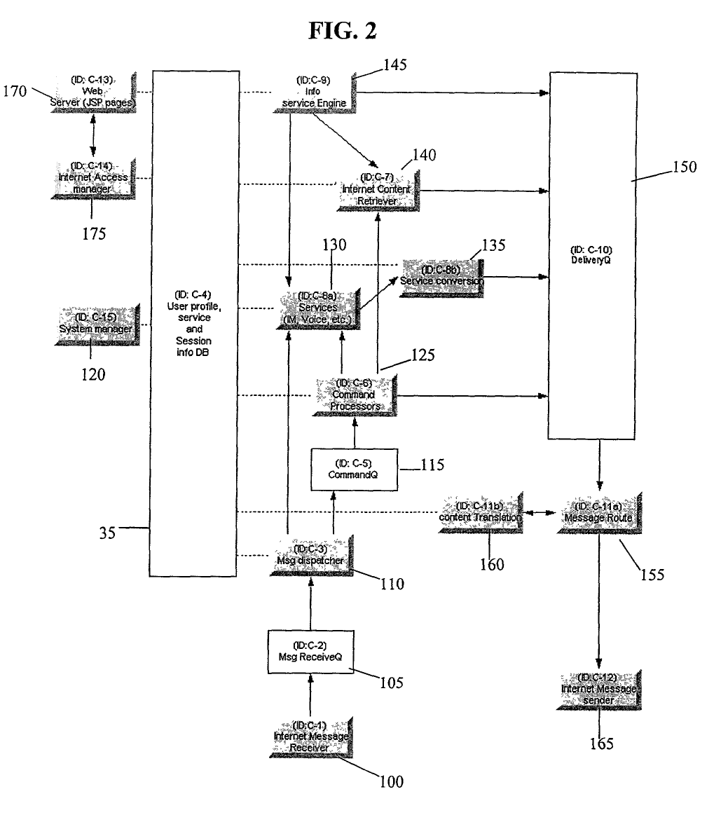

Referring to FIGS. 1 and 2, a mobile application platform 10 is preferably a JAVA software application that enables web pages from the Internet 220 to be translated for display on two-way messaging mobile devices, provides scheduled information to be pushed to one-way or two-way messaging wireless devices and provides other Internet web-based services for two-way messaging wireless devices. A content translator 160 further allows messaging capable mobile handsets and pagers, such as through an SMS gateway 222 (FIG. 1), pager gateway 224, or e-mail based wireless two-way devices to browse Internet sites. An information service engine 145 allows SMS capable mobile devices, e-mail based wireless devices, pagers, and the like, to receive information from the Internet at predefined dates and times.

Referring to FIG. 1, a web server 15 hosts the platform 10 using web Java Server Pages (JSP) 170. The JSP server pages 170 include web pages such as “user signup”, “login”, “system administration”, “service management”, and the like, for processing Internet user's requests. The dynamic contents of the JSP pages 170 use java helper beans 17 to generate these pages. The helper beans 17 function as a controller which uses Enterprise Java Beans (EJB) Session Beans 25 and Entity Beans 30 on an EJB server 20 to access the system database 35 to complete the corresponding business logic of each web client 226 request.

The helper beans 17 are Java classes functioning as the controller to simplify the JSP page 170 construction and modification. These beans 17 provide maximum Java code separation from static HTML contents in the JSP web pages 170. The helper beans 17 are the clients of the system Enterprise Java Beans 25 and 30. The helper beans 17 utilize the platform Entity Beans 30 on the EJB server to access the system database 35.

Enterprise Java Bean application server 20 is used to hold the platformn's Enterprise Java Beans, Session Beans 25 and Entity Beans 30. The EJB application server 20 manages all system EJB components.

Platform Entity Beans 30 are system components which manage system business logic, and which require data persistence with the system database 35. This bean managed persistence method is used with the Entity Beans 30 in order to keep the platform from replying to a specific EJB server vendor. The Session Beans 25 perform platform service tasks by accessing the system database 35 directly or indirectly via the Entity Beans 30, or other Session Beans 25.

A database server 35 is used to hold and manage platform persistent data tables and other persistent data stores such as JMS message queues. Database tables include information utilized in the present invention, including user information, user service session context information, and information predefined on the platform 10 for information push services.

The service processes 40 of the platform are controlled by the system startup property file. The platform services 40 include processing platform commands and messages. The platform services 40 also include information services predefined for timely information push. The services 40 process the user requests from the system interface 45. The timely triggered requests predefined by platform users stored in the database 35 are also processed by the services 40. The service processes 40 utilize platform EJB session beans 25 and entity beans 30, and tools such as JMS, XML parser to complete the services' tasks.

The system interface 45 functions as the sender and receiver of messages between the platform 10 and external entities. The platform system interface 45 includes an SMTP server 47 for receiving incoming Internet e-mails to the platform 10. The host machine of the platform 10 requires Internet connection with a static IP address. Other protocol connectors, such as SMPP, are also part of the system interface 45. The senders and receivers are the platform programs, which perform the client-server connectivity to the external systems. The external systems can be connected to the platform 10 via the Internet or dedicated private lines. E-mail servers are used by these interface components to send platform messages out.

Referring to FIG. 2, the Internet message receiver 100 implements the SMTP protocol as an Internet connector to receive incoming Internet e-mails. The incoming Internet e-mails contain the platform user's requests in a predefined format: <command name> <parameters>. Any e-mail with the platform domain address is acceptable to the receiver. That is, the receiver does not perform e-mail user account validation when the e-mail arrives at the receiver. The user validation is performed by the message dispatcher module 110 later along with an e-mail body command examination. The message dispatcher 110 composes the invalidation response messages in cases of invalidated user or mail contents. The invalidation messages are eventually sent back to the user by another platform module, the Internet message sender 165.

After receiving an e-mail, the Internet message receiver 100 converts the e-mail to an internal message format. This internal message format is based on data source and data handler model of Java Beans Activation Framework. The internal message format includes message body, message type, message “from” address, message “to” address and message data handler information. The converted internal message is placed at the tail of Message Receive Queue 105 for further processing.

The platform system manager 120 can suspend and resume the Internet message receiver 100 based on the platform system status. If the platform system is not able to send messages to users for a certain period of time, the platform 10 suspends the Internet message receiver 100 until the message sender is back to work.

The message receive queue 105 uses a JMS point-to-point message queue. As a client of the message receive queue 105, the Internet message receiver 100 puts the incoming e-mail in the internal message format into the receive queue 105. Another queue client, the message dispatcher 110, listening to the receive queue 105, removes the message from the receive queue 105. The message receive queue 105 uses the system database 35 as its persistent data store.

As mobile users typically do not want to see reply messages after long time delays to their earlier requests, the system manager 120 preferably has options to dump the messages in the receiver queue 105 in case the platform 10 is not able to output messages for a certain period of time.

The message dispatcher module 110 is a client of the message receive queue 105. When messages exist in the message receive queue 105, the message dispatcher 110 removes a message from the head of the queue for message identification processing. The message sender's identity is used to validate the user's legitimacy of using the platform 10. After user validation, the message dispatcher 110 uses both the message sender and recipient names to identify part of the user's requests. The e-mail recipient name indicates whether the request is the start of a platform service. A special recipient name, such as “CMD”, indicates the start of a service request. And the recipient name of a unique sequence number such as “BN234.13” indicates the request message in a middle of a service session.

The message dispatcher 110 also uses the e-mail contents to identify a platform command as part of the user's requests. For all user requests for start up services, the request messages preferably include a <command name> which matches a corresponding service data handler. However, the optional command name in the middle session request messages is not necessary to match a platform data handler. In this case, a unique sequence number is used to match to a specific URL link related to the previously retrieved web page in the service session context.

In order for the message dispatcher module 110 to perform the above identification tasks, the message dispatcher 110 preferably accesses both user and the process transaction data stored in the database 35.

Based on the message contents, if the message does not use a command, the message dispatcher 110 locates the platform service based on the message recipient name in the database 35 and invokes the corresponding platform service to process the request. If the message contains a command, the message dispatcher 110 places the message into the tail of the command queue 115, a JSM point-to-point message queue.

For those request messages that failed to pass the validation or identification, the message dispatcher 110 composes the corresponding error messages and indicates the error handler as the message data handler. Then, the message dispatcher 110 places the composed error response message into the command queue 115.

The system database 35 uses a database server for permanent and transactional data storage. Only EJB beans and JSM queues are preferably allowed to access the database 35 directly for the corresponding stored persistent data. The tables in the database 35 contain system user information, process service information and process transactional session context information.

The system manager 120 periodically checks the stored transactional data in the database 35 and purges it after a certain amount of non-active time. The platform users and system administrators manage their account or system data in the database 35 via system web services.

The command queue 115 is a JSM point-to-point message queue. One of the queue clients, the message dispatcher 110, is responsible for sending the message to the command queue 115. The other client of the queue, the command processor 125, removes the messages from the command queue 115. The command queue 115 uses the system database 35 for data persistence store.

As in the receive queue 105, the system manager 120 dumps the messages in the command queue 115 in case the system could not produce its output for a certain period of time.

The command processor 125 removes the message from the command queue 115. Based on Java Beans Activation Framework, the command processor 125 uses a data content handler to handle the message data source. Based on the internal message command indication in the message data source, the command processor 125 checks data stored in the database 35 and identifies the system action. The platform commands are in the format of an optional <command name> followed by a number of optional <parameters>. The platform available commands are specified in the system startup configuration file.

System commands include the following categories such as: (1) user service sign-up and system administration, such as registration and sign in a particular service; (2) account management functions, such as setup, delete and changing bookmarks; (3) bookmarks to retrieve predefined URL contents; (4) link alias from previous URL pages; and (5) requests in the middle of a service session, wherein the link alias is mapped back to the corresponding URL address by the platform.

The command processor 125 invokes the corresponding data handlers to perform the services based on the message request. The corresponding data handler handles the action to fulfill the user's requests.

The services module 130 includes all system services such as: (1) clients of other Internet based services, such as instant messengers (IM) through instant messaging servers 228 (FIG. 1); (2) system persistent clients which manage client states during a session; (3) client container services that manage system resources, such as JSM messaging queues in case of abnormal system conditions; and (4) platform services, such as user account administration.

The system manager 120 controls the availability of a service during the system startup. There are two kinds of services based on service characteristics. One kind of service is the java program running on its own thread. The other kind of service is a java program managed by a client container.

System services 130 alter the system behavior if the system becomes abnormal. For example, if the system Internet sender service 165 is not working properly, the message queues grow to certain length due to system output halt. In such cases, the system Internet receiver 100 needs to be suspended and the JMS queues need to be dumped after a period of time.

For some system services 130, such as an instant messaging service, content conversion from the original web client format to text based format is required. The service conversion module 135 performs such conversion tasks. The text-based format contains useful information that is easy for mobile end users to read and understand. Session context information related to the service conversion 135 is used in subsequent service processing and is stored in the system database 35 for possible subsequent user's requests.

The Internet content retriever module 140 is responsible for retrieving Internet content specified by a UJRL. The command processor 125 uses the URL to start the content retriever 140. The multi-threaded retrieving process is needed in order to cope with Internet latency. When the content of the URL is retrieved, it is added in to the internal message in mime-type. The message is then placed in the delivery queue 150 for future processing.

In case of failure of retrieving URL content, the Internet content retriever 140 composes the corresponding error message and places it in the delivery queue 150.

The information services engine 145 is a platform process module that performs user-predefined information push services. The platform users use platform web sites to setup their desired services at a specific date and time. The platform 10 stores the user's preferred services and time in the system database 35.

The information service engine 145 preferably starts during system startup. It keeps running to monitor the database data to see if a service time is up for a user. If the service time is up, the service engine 145 constructs an internal message with the user's address and service information.

The information service engine 145 processes two types of services. One type of service does not involve Internet content retrieving (appointment alert). The other type uses a URL to access Internet for its contents.

For services without Internet retrieving, the information service engine 145 prepares an internal message with the service data. Then, the information service engine 145 uses the constructed message to invoke the services module 130 for further processing.

For services with a URL, the information service engine constructs an internal message with the corresponding URL of the service and uses the constructed message to invoke the Internet content retriever 140 to retrieve the Internet content. The Internet content retriever then places the retrieved content in the message and puts the message into the delivery queue 150 for further processing.

The information service engine 145 acts as a system server that starts a system service 130 at predefined time for all platform users. The system users control the behavior of the information service engine 145. After the information service engine 145 initiates a service on behalf of a user, the user is in control to continue the service session. The information service engine 145 is not involved in the subsequence processing for that service.

In order to ensure platform scalability, the information service engine 145 uses multi-threaded processes, each responsible for a certain number of users.

Delivery queue 150 uses a JSM point-to-point messaging queue to provide persistent storage for messages to be delivered to users. The command processor 125, information service engine 145, service conversion 135 and Internet content retriever 140 use a queue provider client to provide the messages to the delivery queue 150. Message router 155 is another client of the delivery queue and is responsible for removing the message from the delivery queue 150 as the queue consumer.

As in other JMS queues in the platform, the delivery queue 150 uses the system database 35 as persistent data store. The system manager 120 controls the delivery queue 150 in case of system output failure. In the failure case, the messages in the delivery queue 150 are dumped after a certain period of time.

The message router 155 is a consumer client of the delivery queue 150. Message router 155 listens to the delivery queue 150 and reads a message at a time when messages exist in the delivery queue 150. The message in the delivery queue 150 is in the internal message format, which contains the MIME-type message body, “from” and “to” addresses. The message router 155 uses a content translation module 160 to do MIME-type conversions for the message body. Then, the message router 155 constructs a deliverable message with the converted message as the message body and the “from” and “to” address as the destination and source address. This constructed message is sent to its destination via the corresponding message senders. If the message is sent out successfully, it is removed from the queue. If the message could not be sent out for whatever reason, the message is marked with a time out for next delivery and stays in the delivery queue. In cases where the Internet message sender 165 is unavailable, the message router 155 checks periodically and resumes normal processing when the Internet message sender 165 is available.

The content translation module 160 utilizes an XML parser to translate messages from one mime-type to another, normally plain text. The translation capability from one type to another is indicated in the system property file. Each mime-type translation is handled by a corresponding translation handler similar to the data source handler specified in Java Beans Activation Framework. The translation type and its corresponding handler are specified in the system property file.

For the URL links inside a processing MIME message body, the content translation module 160 uses a link map, which maps each URL link to a unique number as its alias. The uniqueness of a URL link alias is in the scope of one message. The link map is used as process session context information and stored in system database 35 persistently. The user's source address and the return message “from” address are used to preserve the user's service session in the database 35. The system uses corresponding client containers to manage the service session context data in the database 35 by specifying the timeout amount of terminating a user service session. The timeout amount to terminate a user service session is specified by system startup property file. Content translation module 160 has a dynamic nature in terms of its capability due to the availability of markup language parsers for different MIME-type translation. Once a translation program from one MIME-type to another is available, the system startup property file is modified and the new translation feature is added to the content translation module 160.

Because of the limitation of mobile device display, the targeted translation format is normally text based. The non-text portions of the original MIME-type are not preserved during the content translation process unless they can be represented in simple text format.

Internet message sender 165 uses a Java mail package and an Internet mail server to route the platform outgoing message to the message destination. The message router 155 invokes the Internet message sender 165 to send messages to users. Preferably after the message is sent out successfully, the message is removed from the delivery queue 150. In cases where the mail server is out of service, the Internet message sender 165 constantly checks the mail server via message router 155. The platform system manager 120 starts to manage the system resources when the out of service status of an Internet message sender is reported.

The platform 10 uses JSP technology to provide the platform Internet web server pages 170 for Internet access. These JSP pages 170 reside on a JSP web server 15. The JSP pages 170 functionally have types such as: (1) platform user sign-up and account administration pages; (2) platform system administration pages; and (3) platform user service provision pages.

Referring again to FIG. 1, the JSP pages 170 access the system database 35 via Java helper beans 17, which in turn use platform Java Entity Beans 30. The Java Entity Beans 30 encapsulate the business logic of the corresponding JSP functionality. The helper beans 17, also called controller beans, create better and cleaner JSP pages. The helper beans 17 allow maximum java code separation from the static HTML contents of the web server JSP pages 170.

The platform EJB beans 25 & 30 reside in an EJB server 20. The platform Entity Beans 30 use client managed data persistence to access the system database 35. By using Java RMI technology, the platform JSP web server 15, EJB application server 20 and database server 35 are suitable for distributed computing environments. Because of the preferably pure Java implementation of the platform 10, the platform JSP pages 170, EJB beans 25 & 30 and database server 35 do not depend on any particular computer operation system (platforms). However, those of ordinary skill in the art will appreciate that a pure Java implementation while preferable, is not a requirement of the present invention.

Referring again to FIG. 2, the Internet access manager 175 is composed of Java helper (or controller) beans 17 (FIG. 1) and platform EJB components. The helper beans 17 use the system EJB Entity Beans 20 to access system database 35 to fulfill web client 226 requests. The Internet access manager 175 functions as an Internet access controller to the platform database 35. This Internet access manager 175 enables a simpler JSP page in terms of construction and maintenance of the JSP web pages 170. The system EJB Entity beans 30 are responsible for user account and system data persistence.

System manager 120 is the platform startup and main process; it is responsible for starting up all platform processes and services, including third party programs. The system property files are used to control the availability of platform system processes, capabilities and services. After the system startup, the system manager monitors the status and usage of the platform resources and manages the coordination among all system processes.

In the context of the described architecture, the following use case tables disclose the event process flow for a variety of use cases of the present invention. Preferable, but not mandatory, rules to use the platform as a platform user are: (1) by accessing a platform web site, a user signs up for the platform service with the user's user account information, such as mobile number and e-mail address; (2) to start the platform service, the user sends a message to a predefined account on the platform server, for example, cmd@platform.com, from the user's registered mobile device. The message body includes a command name followed by optional parameters. An example message body is “qt AOL HD”, which has command name “qt”, short for “quote”, and parameters “AOL” and “HD” as stock symbols. The user uses this request message to request stock quotes for AOL and Home Depot; (3) after the user gets a reply message from the platform, using the above example, the stock quotes of AOL and HD, the user has the option to continue the same service session by replying to the message with a corresponding command with the parameters related to the current reply message contents. Based on the platform service type, some service session reply messages by the user s do not need command in the reply message body; (4) a user is not restricted to start a new service at any time; and (5) a reply to platform messages makes a request message related to the previous service session context. However, a service session may expire after certain period of time. In such case, the user is informed that he/she needs to restart the corresponding service to continue.

The use case set forth in Table 1 discloses the process by which a wireless device user accesses a particular HTML, WML, XML, SMIL, SGML, DHTML, CHTML, or other type of web page or file with an associated URL by specifying its absolute URL:

TABLE 1

| Step | Actor | Description |
|---|---|---|
| 1 | User | User composes a message to the platform using his wireless device. |
| | | The message contains a special prefix to identify the message as a |
| | | request for a web page from the Internet (or intranet). For example, |
| | | a message might read as follows: “get www.yahoo.com”, where |
| | | “get” indicates that the message is a request to access a URL. The |
| | | message is sent to a special designated address that is assigned to the |
| | | platform; for example, “9796”. |
| 2 | Platform | The platform receives the message. The platform retains the return |
| | | address of the message for later use. The platform examines the first |
| | | element of the message (“wp” in this example), which identifies the |
| | | message as a request for Internet information. The platform |
| | | examines the second element of the message, which is a valid |
| | | Internet URL. It extracts the URL, and requests the web page |
| | | specified by the URL from the Internet. |
| 3 | Web | The web server at the URL address processes the request and |
| | Server | responds back to the platform with the contents of the requested web |
| | | page. |
| 4 | Platform | The platform receives the contents of the web page, converts the text |
| | | contents of the page into an e-mail message, addresses the message |
| | | using the return address retained in step 2, and sends the message to |
| | | the user. |
| 5 | User | The user receives the message and views the contents from the web |
| | | page. |

First, from the platform system interface 45, Internet Message Receiver 100, receives the mobile user's request message in e-mail format with the content of a command name followed by a completed URL as parameter, for example, “get www.yahoo.com”. The e-mail is converted to the internal message format, which preserves the e-mail sender's name, the recipient's name and the e-mail content. The internal message is placed in the tail of system receive queue 105.

Second, as a listener of the receive queue 105, message dispatcher process 110, preferably a JAVA process, removes the message from the head of the receive queue 105. The dispatcher 110 checks the validity of the request user based on message sender's name. For validated user, the recipient name of the message is used to determine the session context of the request. For example, in this case, a “CMD” recipient name means the first request of services. Based on the recipient name “CMD”, the dispatcher 110 maps the user's request (get) to the corresponding system command and places the modified message with the URL as parameter to a JMS message queue, namely the command queue 115.

Third, the command processor 125 removes the command message from the command queue 115. The system command (“get”) retrieves the URL in the message and triggers the command processor 125 to invoke a Java process, Internet content retriever 140, to access the URL content. After the URL content is obtained, the platform 10 uses a unique system sequence number, such as “bn1234.23”, as the message return account (part of Internet mail address). The message is placed in the system delivery queue 150 with the URL content in MIME format as the message body. The delivery queue 150 is another JMS point-to-point messaging queue.

Fourth, as the delivery queue's 150 listener and consumer, a Java process, message router 155, reads the message from the delivery queue 150. It uses content translation 160 to perform MIME-type translation from the message original MIME-type to user specified type, normally text format. Then, the message router 155 reformats the internal message back to e-mail message format with the user's e-mail address as destination and the newly generated unique sequence number as the e-mail account in the “from address” and uses Internet message sender 165 to send the message back to the user. After the Internet message sender 165 sends the message successfully, the internal message is removed from the delivery queue 150. The user receives the e-mail reply and views the URL content in the e-mail body. The links in the URL pages are mapped to a unique number and resent in flat text format. The use case set forth in Table 2 discloses the process by which a wireless device user can set up a bookmark (or short code) as an alias for a specified URL in the message by which the user requests the content of the URL:

TABLE 2

| Step | Actor | Description |
|---|---|---|
| 1 | User | User composes a message using his wireless device. The message |
| | | contains a special command code (such as a prefix) to identify the |
| | | message as a request to set up a short code/bookmark (such as a |
| | | suffix) to access a URL, the URL itself, and a short code to be used |
| | | for future references to that URL. A sample message might read as |
| | | follows: “set www.x.com/mobile/news.wml xnews”. The message |
| | | is sent to a special designated address that is assigned to the |
| | | platform; for example, “9796”. |
| 2 | Platform | The platform receives the message. It retains the return address for |
| | | later use. The platform examines the first element of the message |
| | | (“set”), which identifies the message as a request for Internet |
| | | information. The platform examines the second element of the |
| | | message, which should be a valid Internet URL. The platform |
| | | examines the third element of the message, which should be the |
| | | short code to be associated with the URL. The platform attempts to |
| | | retrieve the content to verify the URL. |
| 3 | Web | The web server at the URL address processes the request and |
| | Server | responds back to the platform with the contents of the requested web |
| | | page. |
| 4 | Platform | The platform receives the contents of the web page, converts the text |
| | | contents of the page into an e-mail message, addresses the message |
| | | using the return address retained in step 2, and sends the message to |
| | | the user. The platform also creates an entry into the database for the |
| | | user containing 1) the user ID, 2) the short code, and 3) the URL. |
| 5 | User | The user receives the message and views the contents from the web |
| | | page. |

In this case, the command is “set” followed by the URL and bookmark name as parameters.

Following the same first two steps set fort in use case Table 1, the platform command processor 125 adds the bookmark name associated with the URL in the system database 35.

Steps three and four in use case Table 1 remain the same.

The database 35 includes two types of bookmark tables. One is a global bookmark table that lists all URLs and the corresponding bookmark names for all platform users. The other is a user specific bookmark table for each user. Every bookmark name is considered as a command name for the platform and has to be unique for each user. Also, a user has the option to perform a bookmark provision on the Internet by accessing the platform web site.

The use case set forth in Table 3 discloses the process which allows wireless device users to use a bookmark to request the corresponding web page content:

TABLE 3

| Step | Actor | Description |
|---|---|---|
| 1 | User | User composes a message using his wireless device. The message |
| | | uses the short code directly as the request for the corresponding web |
| | | page from the Internet. (A special prefix may optionally be used to |
| | | identify the message as one containing a short code). A sample |
| | | message might read as follows: “xnews”. The message is sent to a |
| | | special designated address that is assigned to the platform; for |
| | | example, “9796”. |
| 2 | Platform | The platform receives the message. The platform retains the return |
| | | address for later use. The platform uses the message (“xnews”in this |
| | | example) to retrieve the corresponding URL from the database for |
| | | the user, and requests the web page specified by the URL from the |
| | | Internet. |
| 3 | Web | The web server at the URL address processes the request and |
| | Server | responds back to the platform with the contents of the requested web |
| | | page. |
| 4 | Platform | The platform receives the contents of the web page, converts the |
| | | contents into an e-mail message, addresses the message using the |
| | | return address retained in step 2, and sends the message to the user. |
| 5 | User | The user receives the message and views the contents. |

Since each bookmark name is treated as a command by the platform 10, by sending a request message with a bookmark name as command to the platform 10, as described in use case Table 1, a user can get the reply of the corresponding URL content in text format. All the process steps are the same as in use case Table 1, except step 3, wherein the command processor 125 has to check system database 35 to map the bookmark name to its corresponding URL.

The use case set forth in Table 4 discloses how a wireless device user can assign a bookmark to the link (URL) of a web page that the user is viewing in text format:

TABLE 4

| Step | Actor | Description |
|---|---|---|
| 1 | User | While a user is viewing a web page supplied to their mobile device |
| | | in a reply from the platform to the user's request for content (see use |
| | | case Table 1), the user can provision a short code for the |
| | | corresponding URL of the message by replying to the message with |
| | | the following mail content. The reply contains a special prefix to |
| | | identify it as a request to set up a bookmark to access the URL |
| | | currently being viewed with a short code. A sample reply might |
| | | read as follows: “bm qHD” (assuming the user is reading a message |
| | | about the stock quote of Home Depot). |
| 2 | Platform | The platform receives the message and retains the return address for |
| | | later use. The platform examines the first element of the message |
| | | (“bm”). The platform examines the second element of the message, |
| | | which should be a short code. The platform will retrieve the URL |
| | | from the message prior to the one to which the user has replied. The |
| | | platform creates a new entry into its user database containing 1) user |
| | | ID, 2) the bookmark alias (qHD), and 3) the URL. Then, the |
| | | platform sends a message back to the user confirming that the short |
| | | code was successfully provisioned. |

The feature of Table 4 helps the user to easily access the linked web page in the future via the bookmark.

After a web page is sent back to a user, the links on the page are referenced by a sequence of numbers. When the user decides to bookmark one of the links, the user replies to the message with the following command and parameters in the message body as “bm <sequence number> <bookmark name>”.

The process steps are similar to those in use case Table 1. A difference is in step 3, wherein the platform command processor 125 recognizes the command and checks the database 35 to map the sequence number to the corresponding URL. Then, the URL and the bookmark name pair are stored in the database table. The content of the URL is retrieved and sent back to the user following steps 3 and 4 as specified in use case Table 1.

The use case set forth in Table 5 discloses how a wireless device user can access a link of a new Internet pages (URL) represented in the current Internet page in flat text format, allowing a user to navigate web pages:

TABLE 5

| Step | Actor | Description |
|---|---|---|
| 1 | User | User composes a message using his wireless device. The message |
| | | contains a special prefix to identify the message as a request for a |
| | | web page from the Internet. A sample message might read as |
| | | follows: |
| | | “get www.xyz.com/mobile/menumain.wml ( or short code)”, where |
| | | “wp” indicates that the message is a request to access a URL. The |
| | | message is sent to a special designated short code that is assigned to |
| | | the platform; for example, “9796”. |
| 2 | Platform | The platform receives the message. The platform retains the return |
| | | address for later use. The platform examines the first element of the |
| | | message (“get”), which identifies the message as a request for |
| | | Internet information. The platform examines the second element of |
| | | the message, which is a valid (direct or indirect) Internet URL. It |
| | | extracts the URL from the body of the message, and requests the |
| | | URL web page from the Internet. |
| 3 | Web | The web server at the URL address transmits the contents of the |
| | Server | requested web page, which contains links to other web pages, back |
| | | to the platform. |
| 4 | Platform | The platform receives the contents of the web page. The platform |
| | | examines the web page and determines that it contains one or more |
| | | links to additional web pages. The platform creates a list of the links |
| | | in the message, including the name of the link, the URL defined by |
| | | the link, and a sequential number, starting at “1”, ”), and an optional |
| | | indicator following the number(such as “1-“) to indicate detailed |
| | | usage of the link(such as use input info for that link, etc.). The |
| | | platform retains a copy of this list. The platform places the content |
| | | of the web page into a message addressed to the return address of the |
| | | user. Wherever a link appears in the message, the platform adds the |
| | | number assigned to the link, along with a special character |
| | | indicating that the link is navigable. The platform sends the |
| | | message to the user, and retains the list of links to be used if the user |
| | | replies to this message. The platform will contain a number of lists |
| | | for one navigation user session to provide “back” capacity so that |
| | | the user can go back to the previous Web pages if needed. |
| 5 | User | The user receives the message and views the contents from the web |
| | | page. The user can then navigate to any of the links specified in the |
| | | list. For this example, the user desires to navigate to the link |
| | | designated in the message as link #1. The user creates a reply to the |
| | | message with the number of the link to which he wishes to navigate, |
| | | in this case “1”. The user sends the message back to the platform. If |
| | | the link has a second usage indicator, the user can reply with “#h 1” |
| | | to get the detail usage of the “1” link via next mail. After reading the |
| | | usage mail, the user can use “#1 parameter1, parameter2, . . . ” to |
| | | navigate to the next page correctly. If the user wants to back to |
| | | previous page, the user can reply the mail with “back #” mail |
| | | content to indicate back to previous “#” page where “#” is a number. |
| 6 | Platform | The platform receives the reply from the user. The platform |
| | | recognizes the message as a reply, and examines the contents of the |
| | | message. The platform identifies the “1” as a request for a link from |
| | | the original message. The platform accesses the retained list of links |
| | | for the user, extracts the URL associated with link #1 with optional |
| | | parameters if applicable, and requests the contents of the URL. |
| 7 | | The remaining steps are identical to steps 3, 4, and 5 in use case |
| | | Table 1. |

As in use case Table 4, after a URL page is returned to the requester, the URL links in the page are mapped to a sequence of numbers. When the user wants to read one of the links, the user needs to reply to the message with a number as the command.

The platform process flows are the same as in use case Table 1, with a difference in step 3. After the message reaches to the platform command processor 125, the command processor 125 checks the system database 35 and finds the link map of the previous URL page based on the message session context (the “from” and “to” address of the user's request e-mail message). Then, the corresponding URL page is retrieved and delivered back to the user as described in steps 3 and 4 of use case Table 1.

Accordingly, one navigation circle is completed. The user can continue the navigation by repeating the same circle sequences.

The use case set forth in Table 6 discloses the process for displaying a user's home page:

TABLE 6

| Step | Actor | Description |
|---|---|---|
| 1 | User | User composes a message using his wireless device. The message |
| | | contains a special code to identify the message as a request for the |
| | | home page. A sample message might read as follows: “hm”. The |
| | | message is sent to a special designated address that is assigned to the |
| | | platform, for example, “9796”. |
| 2 | Platform | The platform receives the message. It retains the return address for |
| | | later use. The platform examines the first element of the message |
| | | (“hm”), which identifies the message as a request for the user's list |
| | | of all short code, bookmarks, and other platform commands. The |
| | | platform retrieves the list from the user database, and optionally |
| | | from a global list of short codes, and sends the list back to user. The |
| | | platform optionally numbers the list as in use case Table 5 above. |
| 3 | User | The user receives the message and views the list. The user |
| | | optionally replies with either a short code or a number representing |
| | | the short code. |
| 4 | | The flow continues as in step 6 of use case Table 5. |

A user's home page preferably contains two bookmark lists. One is a list of bookmarks and their corresponding URLs assigned by the user and the other is a global bookmark table provided by the platform 10 for every user.

The command to display a user's home page is preferably “hm”. Steps 1 and 2 are the same as in use case Table 1. When the request message reaches to the platform command processor 125, it recognizes the command and searches the database 35 to construct the return message with the two bookmark tables. Again, each link in the table is mapped with a sequence number. Then, the constructed reply message is placed in the delivery queue 150. The same steps 3 and 4 of use case Table 1 send the reply message to the user.

When the user reads the home page, the user can use the sequence number to navigate to the corresponding URL link.

The use case set forth in Table 7 describes how a wireless device user can enter input data requested by an Internet page:

TABLE 7

| Step | Actor | Description |
|---|---|---|
| 1-3 | User | User accesses an Internet web page as shown in steps 1 through 3 in |
| | | either use case Tables 1, 2, or 3. |
| 4 | Platform | The platform receives the contents of the web page. The platform |
| | | examines the web page and determines that it contains one or more |
| | | data fields for which the user can enter values. The platform creates |
| | | a list of the fields in the message. Each entry in the list includes 1) |
| | | the name of the field, and 2) a sequential number or other unique |
| | | identifier for the link. The platform places the content of the web |
| | | page into a message addressed to the return address of the user. |
| | | Wherever a field appears in the message, the platform adds the |
| | | unique identifier assigned to the field, optionally including a special |
| | | character indicating that data can be entered into the field. The |
| | | platform sends the message to the user, and retains the list of fields |
| | | to be used if the user replies to this message. |
| 5 | User | The user receives the message and views the contents from the web |
| | | page. The user decides to enter data into one or more fields |
| | | specified in the list. The user creates a reply to the message, and |
| | | enters the data to be supplied to the Internet page in the specified |
| | | data fields. The user sends the reply. |
| 6 | Platform | The platform receives the reply from the user. The platform |
| | | recognizes the message as a reply, and examines the contents of the |
| | | message. The platform extracts the data from the original message. |
| | | The platform accesses the URL page associated with this reply, |
| | | “fills” the data fields in the page from the data elements contained in |
| | | the reply, and transmits the appropriate strings back to the URL |
| 7 | Web | The web server at the URL address processes the request, including |
| | Server | the data in the indicated fields and responds back to the platform |
| | | with the requested information in the form of an Internet page. |
| 8 | | The process loops back to step 4 of this use case or use case Table 5. |
| | | The user may continue to enter data into successive Internet pages or |
| | | to navigate from one Internet page to another as many times as |
| | | desired. |

The platform request messages are based on <command name> <parameters > format. When a web page has input fields, the input field tags and data are represented in the parameter parts. Input field tags are mapped to a sequence alphabet, such as <a, b, c, etc.>. Once a mobile user reads a web page in text format from the platform, the user can reply to the message with the link sequence number followed by a sequence of parameters in a format such as: “0a=<”tag A's input data”> b=<”tag B's input data”>.

The first two steps are the same as in use case Table 1. When the reply message reaches the platform, the command processor 125 checks the database 35 for session context information (link map) and maps the “0” back to its original reference link (URL) and “a”, “b” tag names back to their original tag names. The reconstructed URL request with the correct tags and input fields are sent to the content retriever 140 to process the request as stated in step 3 in use case Table 1. The request results are then sent back to the mobile user in the same way as in step 4 in use case Table 1.

The URL bookmark, also considered a command for the platform, can be managed via the web site. The use case set forth in Table 8 shows one example how a web user sets up a bookmark via web browser:

TABLE 8

| Step | Actor | Description |
|---|---|---|
| 1 | User | User logs into platform provision Web site. |
| | | Select the “add short code” action |
| | | and type in the specified URL and |
| | | corresponding short code, then send the |
| | | request to platform. |
| 2 | Platform | The platform receives the http request. |
| | | The platform examines the URL, which should |
| | | be a valid Internet URL. The platform will |
| | | try to retrieve the content to verify the URL. |
| | | If the URL is valid, the platform examines the |
| | | short code to be assigned to the URL to make |
| | | sure that it has not been used. The platform |
| | | creates a new entry into its user database |
| | | containing user ID, the short code, and the URL. |
| | | Then, the platform sends the short code set |
| | | successful response back to the user. If the URL |
| | | or the short code is not valid, the platform |
| | | will send a corresponding response to inform the user. |

First, a platform user uses a web browser to access the platform JSP pages 170. After inputting the user's name and password, the user's request is processed by Internet access manager 175. The Internet access manager 175 logs into the platform database 35 and accesses the user's account.

Second, upon the user's request, the Internet access manager 175 retrieves the user's personal bookmark list and platform global command list. Internet access manager 175 creates a response to the request back to web client 226 with the two lists.

Third, the user views all the commands or bookmarks. By selecting “add” bookmark action on the web page 170, the user can enter the bookmark name and the corresponding complete URL.

Again, repeating step 1 and 2, the platform processes the new request. If the new bookmark name is unique, it is accepted by the platform. If it is not, it asks the user to select a new name for the bookmark.

A mobile user can also use a mobile device in the present invention to manage the user's command (bookmark) list. The use case set forth in Table 9 shows how to delete a bookmark via a mobile device:

TABLE 9

| Step | Actor | Description |
|---|---|---|
| 1 | User | User composes a message using his wireless device. |
| | | The message contains a special prefix to identify |
| | | the message as a request to remove a URL short |
| | | code or bookmark. A sample message might read as |
| | | follows: “del xnews”. The message is sent |
| | | to a special designated address that is assigned |
| | | to the platform; for example, “9796”. |
| 2 | Platform | The platform receives the message. It retains |
| | | the return address for later use. The platform |
| | | examines the first element of the message |
| | | (“del”), which identifies the message as a |
| | | request for removing a short code or bookmark. |
| | | The platform examines the second element of the |
| | | message, which should be a valid short code or |
| | | bookmark. The platform will try to remove it and |
| | | associated URL from user database. Then, the |
| | | platform sends the short code removal successful |
| | | message back to the user. |

To delete a user's bookmark, the user needs to use a system command, such as “del”, followed by a <bookmark name> as the parameter. The request message is sent to the “CMD” account of the platform 10.

Steps 1 and 2 of this use case are the same as in use case Table 1. When the request message reaches the platform command processor 125, the bookmark and its associated URL are deleted from the user's bookmark list in the database 35.

Following step 4 of use case Table 1, the result message is delivered to the mobile user.

The use case set forth in Table 10 is another example of bookmark management via web browser:

TABLE 10

| Step | Actor | Description |
|---|---|---|
| 1 | User | User logs into platform provision Web site. Select the “remove |
| | | short code” action and type in the specified short code or bookmark, |
| | | then send the request to platform. |
| 2 | Platform | The platform receives the http request. The platform examines the |
| | | short code or bookmark, Then, the platform will delete the entry |
| | | associated with the short code or bookmark from its user database. |
| | | The platform sends the short code removal successful response |
| | | back to the user. |

The process flows are the same as in use case Table 8 with a difference of choosing the “delete” bookmark action on the web page.

A mobile user can also request a help menu on the usage of each system command or global bookmark. The use case set forth in Table 11 illustrates that process:

TABLE 11

| Step | Actor | Description |
|---|---|---|
| 1 | User | User composes a message using his wireless device. |
| | | The message contains a special code to identify the |
| | | message as a request for help on a short code. A |
| | | sample message might read as follows: |
| | | “hp <short code>” |
| | | The message is sent to a special designated address |
| | | that is assigned to the platform; for example, |
| | | “9796”. |
| 2 | Platform | The platform receives the message. It retains the |
| | | return address for later use. The platform examines |
| | | the first element of the message (“hp”), which |
| | | identifies the message as a request for the usage of a |
| | | short code. The next element is the short code. The |
| | | platform retrieves the usage info for the short code |
| | | and sends the message back to user |
| 3 | User | The user receives the message and view the usage of |
| | | the short code. |

Via a mobile device, a user composes a request message with a command such as “hp” followed by a <bookmark name> as parameter and sends the request message to the “CMD” account of the platform.

Following step 1 and 2 in use case Table 1, when the message reaches the command processor 125 of the platform, the command is recognized and the help content of the command is retrieved from the database 35. The command processor 125 constructs the reply message with the help content and places the message in the delivery queue 150.

Step 4 of use case Table 1 then sends the message back to the user.

The platform 10 in the present invention has the capability to extend web-based services to mobile users. The use case set forth in Tables 12-18 disclose the process flow for a mobile user to use Instant Messaging. Table 12 discloses logon to a web Instant Messaging server:

TABLE 12

| Step | Actor | Description |
|---|---|---|
| 1 | User | Logon to provision site. Select user’s online instant |
| | | messaging provider. Provide the login name and |
| | | password of the online instant messaging service. |
| | | Then, press “test” button. |
| 2 | Platform | The platform will use the provided login name |
| | | and password to logon to the instant messaging |
| | | service. If successfully logon, reply |
| | | “OK” to the user. If not, reply |
| | | “logon failure” to the user. |
| 3 | User | If failed, repeat step 1 and 2 with correct info or stop. |

This use case set forth in Table 13 discloses how a mobile user starts the instant messaging service by logon to the instant messaging service:

TABLE 13

| Step | Actor | Description |
|---|---|---|
| 1 | User | Send a message to platform with instant message |
| | | login command. |
| 2 | Platform | Upon user’s login request, use user’s instant |
| | | messaging info to logon to the predefined instant |
| | | messaging server. Send user a message about login |
| | | status and the buddy list. |

In use case Table 13, a mobile user composes a request message to logon to a web based instant message server by using the command name <IM> without parameters and sends the message to the platform “CMD” account.

Following step 1 and 2 in use case Table 1, when the message reaches the command processor 125 of the platform 10, the user's IM login name and password are retrieved from the database.

Then the platform corresponding service process 130 is invoked. Service process 130 uses the user's IM login name and password to connect to the Internet IM server 228 and tries to logon to it. Once the user is successfully logged on, the IM user's session information is stored in the user session context table in the database 35. Then, the service conversion process 135 is responsible for reformatting the IM service response content to flat text format. The internal message with the reformatted IM response content is placed in the delivery queue 150. As in use case 1, step 4 sends the response message back to the user.

The use case set forth in Table 14 discloses how a mobile user stops the instant messaging service by logout of the instant messaging service:

TABLE 14

| Step | Actor | Description |
|---|---|---|
| 1 | User | Send a message to platform with instant |
| | | message logout command. |
| 2 | platform | Upon user’s logout request, logout the online |
| | | instant messaging server and send user a message |
| | | about logout status. |

Referring again to Table 13, once the response message is sent back to the user, the user can continue the service, such as the use cases set forth in Tables 15-18, by sending the message back to the platform using the command parameter schema.

The use case set forth in Table 15 discloses how a mobile user receives an instant message from a buddy after logon:

TABLE 15

| Step | Actor | Description |
|---|---|---|
| 1 | Platform | After the platform receives an instant message |
| | | from a buddy, it stores the buddy name and message |
| | | id. Then, it sends the reformatted message to the |
| | | mobile user’s mobile device. |
| 2 | User | The user receives the buddy’s instant message |
| | | from the platform and reads it. |

Since the user is available on the IM server, another IM user on the Internet can see the user's logon status and send a message to the mobile user. The services thread 130 receives the message from the IM server on behalf of the mobile user. Then, thread 130 stores the sender's IM user name in the database session context. Then, services thread 130 calls the service conversion 135 to reformat the message and sends the message to the mobile user.

The use case set forth in Table 16 discloses how a mobile user sends an instant message to a buddy after logon.

TABLE 16

| Step | Actor | Description |
|---|---|---|
| 1 | User | Send a message to platform with instant |
| | | message send message command and the buddy’s |
| | | name. |
| 2 | Platform | Upon user’s send message request, the |
| | | platform reformats the user’s send request and |
| | | send the instant message to the online instant |
| | | messaging server. If failed to do |
| | | so, sends a message back to the user to inform the |
| | | failure reason. |

The use case set forth in Table 17 discloses how a mobile user can reply an instant message after receiving it:

TABLE 17

| Step | Actor | Description |
|---|---|---|
| 1 | User | Continue from step 2 of use case Table 15. If the |
| | | user decides to reply the instant message from a |
| | | buddy, just reply the message with message |
| | | content. |
| 2 | Platform | The platform receives the replied message. |
| | | Retrieve the original message ID and find the sender’s |
| | | name. Send the replied message back to the original |
| | | buddy. If failed, send a failure message to the |
| | | user with failure reason. |

Once the message reaches the mobile user, the user decides to talk to that IM web user. The mobile user can do so by just replying to the message. This time, the reply message does not need a command name in order for the platform to post an Instant message to the IM web server. The reply message only contains the message itself. Once the message reaches to the platformn command processor 125, based on the session context, the original IM web user name is retrieved from the database 35 and the mobile user's message is sent to the IM server for that IM web user.

The use case set forth in Table 18 discloses how a mobile user can use IM service to send a chat message to an unavailable buddy on an IM server:

TABLE 18

| Step | Actor | Description |
|---|---|---|
| 1 | User | After logon to an IM service. Sends a message to |
| | | a buddy regardless who is available or not. |
| 2 | Platform | The platform receives the user’s send request. |
| | | It checks the availability of the destination |
| | | buddy. If the buddy is not available, retrieve the |
| | | user’s mobile device address and/or office e-mail |
| | | address from the buddy’s profile (this will require |
| | | the user to provide mobile device addresses and office |
| | | e-mail addresses for all users in the user’s buddy |
| | | list.). The platform will send the user’s IM message |
| | | with corresponding IM server info to the buddy’s |
| | | mobile device and office address with current user’s |
| | | mobile address as the “from address”. This way, |
| | | the destination buddy can chose to reply by e-mail to |
| | | the current user or logon the IM server to join the chat. |

In an alternative text embodiment of the invention, a user may request scheduled content from a specified URL to be delivered to a mobile device. The use case set forth in Table 19 discloses how a predefined bookmark, including an absolute URL or code therefor, may be scheduled and the text data associated with the URL-identified file “pushed” to a mobile user at a predefined time by the information services engine 145:

TABLE 19

| Step | Actor | Description |
|---|---|---|
| 1 | User | User logs into platform provision web site. Selects |
| | | one or more bookmarks/URLs for time and date |
| | | scheduled delivery of text content from the |
| | | associated web page(s). |
| 2 | Platform | At the scheduled time for respective web page |
| | | retrieval, the platform retrieves the content |
| | | associated with the bookmark/URL, converts it |
| | | to text data, and delivers the text data to the |
| | | mobile user. |

First, a mobile user uses the platform web site to setup a push service (a bookmark) at a predefined date and time.

Second, system information service engine 145 checks the database user's push request table and determines the user's push request time is met. The information service engine 145 then constructs a new internal message with the user predefined service (a bookmark in this case), the user's mobile address, and a unique reply sequence number retrieved from database. The information service engine then invokes the Internet retriever 140 as in step 3 of use case Table 1 to retrieve the content of that bookmark. Following steps 3 and 4 of use case Table 1, the service content is delivered to the mobile user's address.

After receiving the platform pushed messages, a user has the option to continue the services by replying to the message as disclosed in use case Table 5.

Those of ordinary skill in the art will appreciate that the present invention supports wireless delivery of text data for any message type that has a “from” address and a “to” address, or source and destination addresses. Exemplary types of messages having compatibility for wireless transfer in the present invention include SMS, RFC822 E-mail, Flex and Reflex paging protocol, and TAP. Accordingly, while the invention has been described with reference to the structure disclosed, it is not confined to the details set forth, but is intended to cover such modifications or changes as may fall within the scope of the following claims.

What is claimed is:

1. A method for delivering data to a wireless device comprising:
a) receiving a request for text data associated with a file, wherein said file is identified by a Uniform Resource Locator;
b) retrieving the file containing the text data;
c) converting the text data from the file into an electronic message; and
d) sending the electronic message to a message address associated with a wireless device.

2. The method of claim 1 wherein the file is incompatible with the wireless device.

3. The method of claim of claim 2 wherein the file is a markup language file.

4. The method of claim 3 wherein the markup language file is selected from the group consisting of HTML, WML, XML, SMIL, SGML, DHTML and CHTML.

5. The method of claim 4 wherein the electronic message includes source and destination addresses.

6. The method of claim 2 wherein the request originates from the message address associated with the wireless address.

7. The method of claim 6 wherein the request includes a command code and an Internet Uniform Resource Locator, wherein the Internet Uniform Resource Locator is the Uniform Resource Locator.

8. The method of claim 7 wherein the command code specifies to a receiving platform that the request is for the retrieval of the text data from the Internet.

9. The method of claim 8 wherein the request includes a short code, and wherein the command code indicates to a receiving platform that the short code corresponds to the Internet Uniform Resource Locator in any subsequent request originating from the wireless device for the text data.

10. The method of claim 4 wherein the request originates from the message address associated with the wireless address.

11. The method of claim 10 wherein the request includes a command code and an Internet Uniform Resource Locator, wherein the Internet Uniform Resource Locator is the Uniform Resource Locator.

12. The method of claim 11 wherein the command code specifies to a receiving platform that the request is for the retrieval of the text data from the Internet.

13. The method of claim 11 wherein the request includes a short code, and wherein the command code indicates to a receiving platform that the short code corresponds to the Internet Uniform Resource Locator in any subsequent request originating from the wireless device for the text data.

14. The method of claim 2 wherein the request includes a short code corresponding to the Uniform Resource Locator.

15. The method of claim 2 further comprising receiving a reply to the message wherein the reply assigns a short code identifier to the file associated with the Uniform Resource Locator.

16. The method of claim 15 wherein the request and the reply both originate from the message address associated with wireless device.

17. The method of claim 4 further comprising receiving a reply to the message wherein the reply assigns a short code identifier to the file associated with the Uniform Resource Locator.

18. The method of claim 17 wherein the request and the reply both originate from the message address associated with wireless device.

19. The method of claim 2 further comprising:
i) identifying one or more hyperlinks in the file;
ii) associating a unique link identifier with each of said one or more hyperlinks; and
iii) including the unique link identifier for each of said one or more hyperlinks in the message.

20. The method of claim 19 wherein the message includes the Uniform Resource Locator for each of said one or more hyperlinks.

21. The method of claim 19 further comprising:
i) receiving a reply to the message wherein said reply includes a unique identifier corresponding to a hyperlink; and
ii) repeating steps (a)-(d) to provide the text data for a second file associated with the Uniform Resource Locator of the hyperlink.

22. The method of claim 21 wherein the request originates from the message address associated with the wireless device.

23. The method of claim 19 wherein the request originates from the message address associated with the wireless device.

24. The method of claim 2 further comprising:
i) identifying one or more data entry fields in the file;
ii) associating a unique data entry identifier with each of said one or more data entry fields; and
iii) including the unique data entry identifier for each of said one or more data entry fields in the message.

25. The method of claim 23 wherein the request originates from the message address associated with the wireless device.

26. The method of claim 23 further comprising:
i) receiving a reply to the message wherein said reply includes a field entry and a unique data entry identifier corresponding to a data entry field; and
ii) entering the field entry into the data entry field of the file.

27. The method of claim 26 wherein both the request and the reply originate from the message address associated with the wireless device.

28. The method of claim 26 further comprising repeating steps (a)-(d) to provide the text data to the wireless device for a second file generated after entering the field entry.

29. The method of claim 2 wherein the request originates from a user's pre-selection of desired content to be sent to the wireless device.

30. The method of claim 29 wherein the pre-selection is conducted from a web page.

31. The method of claim 29 wherein the pre-selection is conducted from an electronic message.

32. The method of claim 30 wherein the pre-selection includes scheduling delivery of requested content at one or more specified times.

33. A mobile data delivery system comprising:
a) a request receiver for receiving a request for text data associated with a file;
b) a content retriever for retrieving the file based on the file's Uniform Resource Locator on a computer network;
c) a converter for converting the text data from the file into an electronic message; and
d) a message sender for sending the electronic message to a message address associated with a wireless device.

34. The system of claim 33 wherein the file is incompatible with the wireless device.

35. The system of claim 34 wherein the file is selected from the group consisting of HTML, WML, XML, SMIL, SGML, DHTML and CHTML.

36. The system of claim 35 wherein the request originates from the message address associated with the wireless address.

37. The system of claim 33 wherein the request originates from the message address associated with the wireless address.

38. The system of claim 37 wherein the file is selected from the group consisting of HTML, WML, XML, SMIL, SGML, DHTML and CHTML.

39. The system of claim 37 further comprising a command processor for a conducting a function corresponding to a command identifier in the request.

40. The system of claim 39 wherein the function is selected from the group consisting of assigning a short code to the uniform resource locator associated with the file, retrieving the text data, retrieving a hyperlink file, entering entry data into a data field of the file, creating a bookmark for the file, updating a database, requesting data from a database, deleting a bookmark, deleting a short code, and providing one or more menus.

41. The system of claim 40 wherein the file is incompatible with the wireless device.

42. The system of claim 40 wherein the file is selected from the group consisting of HTML, WML, XML, SMIL, SGML, DHTML and CHTML.

43. The system of claim 39 wherein the file is incompatible with the wireless device.

44. The system of claim 39 wherein the file is selected from the group consisting of HTML, WML, XML, SMIL, SGML, DHTML and CHTML.
